(19) United States
(12) Patent Application Publication
(10) Pub. No.: US 2025/0330773 A1
(43) Pub. Date: Oct. 23, 2025

(54) SYSTEM AND METHOD FOR VERIFYING PRESENCE AT LOCATION

(71) Applicant: Universal City Studios LLC, Universal City, CA (US)

(72) Inventors: Jacob David Allinson, Orlando, FL (US); Cole Hirapara, Orlando, FL (US)

(21) Appl. No.: 18/643,162

(22) Filed: Apr. 23, 2024

(51) Int. Cl. H04W 4/021; H04W 4/029

(52) U.S. Cl. CPC H04W 4/021; H04W 4/029

(57) ABSTRACT

A network node includes processing circuitry and memory. The memory is accessible by the processing circuitry and stores instructions that, when executed by the processing circuitry, cause the processing circuitry to perform operations that include establishing a connection with a mobile device, transmitting, to the mobile device, a value, receiving, from the mobile device, a modified value generated by the mobile device in response to receiving the value, comparing the modified value to an expected value of the modified value, in response to the modified value matching the expected value of the modified value, generating a verification that the mobile device is within range of the network node, and transmitting the verification to a server.

### BACKGROUND

The present disclosure relates generally to verifying the presence of a mobile device at a location.

Guests visiting an amusement park may utilize a mobile application running on a mobile device to enhance their experience at the amusement park. For example, a guest may utilize the mobile application to view maps of the amusement park, view wait times for attractions within the amusement park, join virtual queues for attractions within the amusement park, place orders for food or merchandise, participate in promotions, reserve tickets for events, receive messages with information about weather, safety, attractions being closed, and so forth. However, it is now recognized that making some of these features available to mobile devices that are not present at the amusement park may result in these features being abused by mobile devices that are not present in the park, resulting in inefficient operation of various functions of the amusement park. For example, systems for managing a restaurant in the amusement park, a virtual queue of an attraction, a ticket reservation tool for an event at the amusement park, and so forth, may be overwhelmed by requests from mobile devices that are not present at the amusement park, resulting in poor experiences for amusement park guests attempting to use these features. Accordingly, techniques for verifying a mobile device's presence in the amusement park are needed.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below

In an embodiment, a network node for location verification includes processing circuitry and memory. The memory is accessible by the processing circuitry and stores instructions that cause the processing circuitry to perform various operations upon execution. The operations may include establishing a connection with a mobile device, transmitting a value to the mobile device, receiving a modified value from the mobile device that was generated in response to receiving the value, comparing the modified value to an expected value of the modified value, generating a verification that the mobile device is within range of distance of the network node if the modified value matches the expected value, and transmitting the verification to a server.

In an embodiment, a non-transitory computer readable medium stores instructions that, when executed by processing circuitry, cause the processing circuitry to perform operations various operations. The operations may include establishing a connection with a network node of a plurality of network nodes within a network, transmitting a value to the network node, receiving a modified value from the network node that was generated in response to receiving the value, transmitting the modified value to a server, and receiving an indication from the server that one or more location-restricted capabilities of a mobile application are enabled based on the modified value matching an expected value of the modified value.

In an embodiment, a method for location verification includes receiving, from a mobile device, a modified value that was generated by a network node of a network in response to receiving an original value from the mobile device, comparing the modified value to an expected value of the modified value, determining that the mobile device is located inside of a boundary defining a geographical area if the modified value matches the expected value, and enabling one or more location-restricted capabilities of a mobile application by the mobile device if the mobile device is located inside of the boundary defining the geographical area.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of an amusement park, in accordance with an embodiment of the present disclosure;

FIG. 2 is a schematic illustrating how a mobile device's presence within the amusement park of FIG. 1 is verified using a network node as a witness, in accordance with an embodiment of the present disclosure;

FIG. 3A illustrates a screen of an application running on the mobile device of FIG. 2 displaying a notification that a guest's presence in the amusement park must be verified before a request is processed, in accordance with an embodiment of the present disclosure;

FIG. 3B illustrates a screen of the application running on the mobile device of FIG. 2 that appears once location verification has been initiated, in accordance with an embodiment of the present disclosure;

FIG. 3C illustrates a screen of the application running on the mobile device of FIG. 2 asking whether to verify the location without sharing location data, in accordance with an embodiment of the present disclosure;

FIG. 4 is a block diagram of example components of a computing device that could be used as the mobile device, the network node, and/or a cloud/remote server, or some other device within the amusement park of FIGS. 1 and 2, in accordance with an embodiment of the present disclosure;

FIG. 5 is a swim lane diagram illustrating an embodiment of a process for verifying the mobile device's presence within the amusement park, in accordance with an embodiment of the present disclosure; and

FIG. 6 is a swim lane diagram illustrating an embodiment of a process for verifying the mobile device's presence within the amusement park, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 percent of a target, within 1 percent of a target, within 5 percent of a target, within 10 percent of a target, within 25 percent of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure is directed to techniques for verifying the presence of a mobile device within a location defined by a boundary (e.g., an amusement park). Specifically, the amusement park may have a network that communicatively couples multiple network nodes. A zero-knowledge proof (ZKP), and more specifically, a witness indistinguishable proof (WIP), may be performed between the mobile device and one of the network nodes to verify the mobile device's presence within the amusement park. For example, the mobile device establishes a connection with a network node. A value may be transmitted from the mobile device to the network node, or from the network node to the mobile device. The value may be an alphanumeric character string. In an embodiment, the value may be a key (e.g., an encryption key, such as a public key or a private key), a value of a key-value pair associated with a public key or a private key and retrieved from a table, an alphanumeric character string that is not associated with a key, or some combination thereof. Upon receipt of the value, the network node or the mobile device modifies the value by performing some operation (e.g., a hash). For example, the value may be hashed using a locally stored public or private key, or some other operation may be performed on the value to modify the value in a predictable way. The modified value may then be sent back to the mobile device or the network node. Upon receipt of the modified value, the mobile device or the network node may transmit the modified value to a server for verification, or the mobile device or the network node may verify the modified value locally by comparing the modified value to an expected value for the modified value (e.g., retrieved from a hash table). If the received modified value matches the expected value for the modified value, the location of the mobile device is verified and one or more location-restricted capabilities are enabled for the mobile device. In some embodiments, which of the network nodes was used to verify the presence of the mobile device within the amusement park may be obscured from the server.

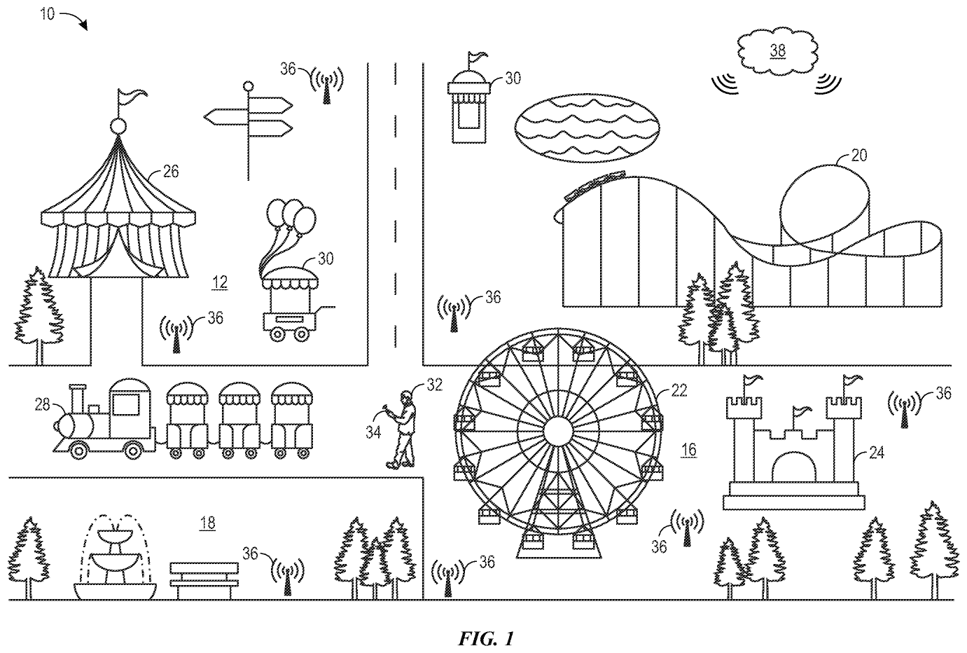

FIG. 1 is a schematic of an amusement park 10. The amusement park 10 may include and/or be separated into one or more sections or lands, such as a first land 12, a second land 14, a third land 16, and a fourth land 18. Each of the lands 12, 14, 16, 18 may include one or more attractions. As shown in FIG. 1, the attractions may include rides, such as roller coasters 20, carousels 22, or attractions in which a guest is moved through an environment, environments through which guests walk, such as castles 24, performance venues 26, and so forth. The amusement park may also include transportation 28, such as trams, trains, trolleys, and so forth that are configured to move guests within or between lands 12, 14, 16, 18 of the amusement park 10. Further, the amusement park may include one or more vending locations 30. The vending locations 30 may be stationary (e.g., a storefront), mobile (e.g., a cart), or semi-mobile (e.g., a stand), and configured to sell items, such as food, merchandise, toys, souvenirs, toiletries, and so forth to guests.

A guest 32 visiting the amusement park 10 may utilize a mobile device 34 (e.g., a smartphone, tablet, etc.) equipped with a mobile application or configured to access a webpage to perform various tasks while inside the amusement park 10. For example, the guest 32 may utilize the mobile device 34 to join a virtual queue to experience an attraction, place an order for food, order or reserve merchandise or souvenirs, participate in promotions (e.g., give-aways, special edition merchandise releases, etc.) within the amusement park 10, attend, join queue for, or reserve tickets for events within the amusement park 10, signup to receive messages (e.g., related to weather, safety, attractions being closed, etc.) intended for guests 32 within the amusement park 10, and so forth. However, before allowing a guest 32 to perform some functions via mobile device-based application, an operator of the amusement park 10 may wish to verify that the guest 32 is actually located within the park. The operator of the amusement park 10 may limit some functionality of the mobile device-based application to mobile devices 34 that can prove that the mobile device 34 is located within the amusement park 10. For example, the operator of the amusement park 10 may wish to prevent a virtual queue for an attraction or event being filled by requests from mobile devices that are not located in the park. Similarly, the operator of the amusement park 10 may wish to prevent orders for items, such as food, merchandise, souvenirs, and so forth being placed by mobile devices 34 that are not located in the amusement park 10 and unlikely to be picked up. Further, the operator of the amusement park 10 may wish to limit messages to guests 32 that are actually located in the amusement park 10, in one or more particular lands 12, 14, 16, 18, and/or located in or near an attraction. However, for privacy reasons, a guest 32 may wish not to share location data from their mobile device 34 with the application for the amusement park 10. Further, the operator of the amusement park 10 may not wish to have access to location data for mobile devices 34 belonging to guests 32 in the amusement park 10.

Accordingly, the present techniques enable verification that a mobile device 34 is located inside the amusement park 10 without access to the mobile device's 34 location data or otherwise knowing the exact location of the mobile device 34. Verification may be accomplished using zero-knowledge proofs (ZKPs), and more specifically, witness-indistinguishable proofs (WIPs) to prove that a statement is true (e.g., that a mobile device 34 is located inside the amusement park 10) without disclosing the specific details of statement (e.g., the exact location of the mobile device 34).

For example, multiple network nodes 36 (e.g., routers, switches, edge devices, internet of things (IoT) devices, or other processor-based computing devices) may be distributed throughout the amusement park 10. A mobile device 34 may rely on one or more of the nodes 36 to act as a witness to a server 38 (e.g., a cloud server, remote server, on-prem server, etc.) that the mobile device 34 is located inside the amusement park 10. The mobile device 34 may participate in an exchange with one or more of the nodes 36 and/or a server 38 in order to verify to the server 38 that the mobile device 34 is located inside the amusement park 10. As will be described in more detail below, the exchange may include pings transmitted between the mobile device 34 and one or more of the nodes 36. For example, public/private key pairs may be exchanged or used to modify exchanged values. Accordingly, different public/private key pairs may be used for different sections of the amusement park 10 (e.g., lands 12, 14, 16, 18) of specific attractions within the park, to determine the mobile device's 34 presence in a particular section of the amusement park 10 or near a particular attraction without knowing the exact location of the mobile device 34. In an embodiment, one or more of the nodes 36 may attempt to establish a connection with the mobile device 34 and assign the mobile device 34 an address or ID. Such communication may utilize cellular networks, Bluetooth, Wireless Fidelity (WiFi), Global Positioning System (GPS), Radio Frequency Identification (RFID), Near Field Communication (NFC), and so forth, or some combination thereof.

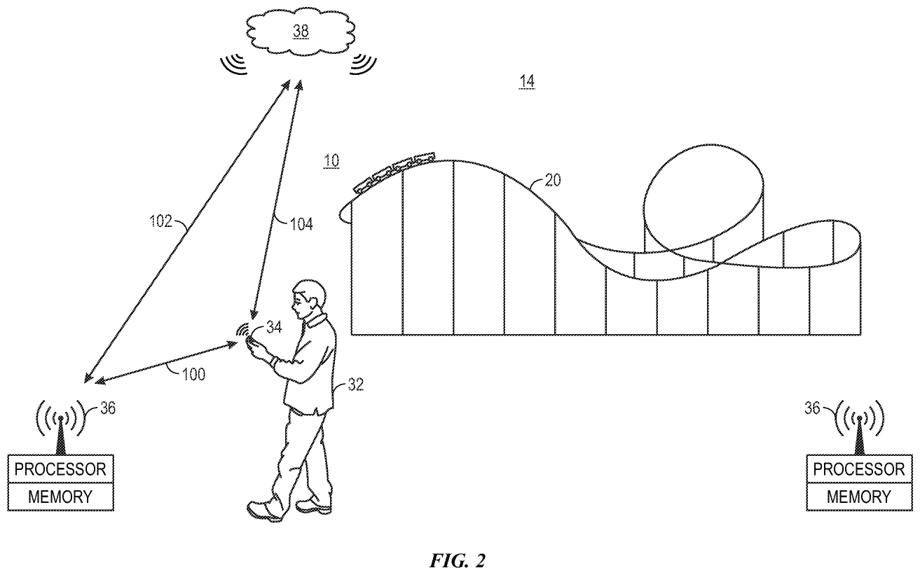

FIG. 2 is a schematic illustrating how the mobile device's presence within the amusement park 10 of FIG. 1 is verified using one of the nodes 36 of FIG. 1 as a witness. As shown, in order to verify that a mobile device 34 is located in the amusement park 10, the mobile device 34 pings the node 36 (arrow 100) or one of the nodes 36 pings the mobile device 34 (arrow 100). Based on the response, the node 36 that participated in the exchange verifies to the server 38 (arrow 102) that the mobile device 34 is located within range of the node 36, and thus, is within the bounds of the amusement park 10. Alternatively, the mobile device 34 may transmit to the server 38 (arrow 104) proof, such as verification from the node 36, that the mobile device 34 is located within the amusement park 10.

The device that initiates a ping may be referred to as a sender. Thus, in the examples above, the mobile device 34 is the sender when it pings the node 36 or the node 36 is the sender when it pings the mobile device 34. In an embodiment, the ping may utilize a public/private key pair. For example, the sender of the ping transmits a value to the recipient of the ping. The recipient of the ping performs an operation on the value, such as hashing the value using its local key, to modify the value, and then transmits the modified value back to the sender of the ping or to the server 38. The sender of the ping or the server 38 confirms the modified value if the modified value has been manipulated in an expected way, for example by hashing with a locally stored key.

Accordingly, in one arrangement, the mobile device 34 transmits the value, the value is received by one of the nodes 36, the value is modified by the node 36 using a locally stored key to generate a modified value, and the modified value is transmitted by the node 36 back to the mobile device 34. The modified value may be presented to the server 38, either by the mobile device 34 or the node 36 to establish that the mobile device 34 is located inside the amusement park 10. In another arrangement, one or more of the nodes 36 transmit the value, the value is received by the mobile device 34, the value is modified by the mobile device 34 using a locally stored key to generate a modified value, and the modified value is transmitted by the mobile device 34 back to the node 36. The modified value may be presented to the server 38, either by the mobile device 34 or the node 36 to establish that the mobile device 34 is located inside the amusement park 10. Verification of the presence of the mobile device 34 may be based on the modified value and, as such, the server 38 may be unable to determine which of the nodes 36 was acting as a witness for the mobile device 34. Different public/private key pairs may be used for different sections of the amusement park 10 or specific attractions within the park, to determine the mobile device's 34 presence in a particular section of the amusement park 10 or near a particular attraction without knowing the exact location of the mobile device 34. Such communication may utilize cellular networks, Bluetooth, Wireless Fidelity (WiFi), Global Positioning System (GPS), Radio Frequency Identification (RFID), Near Field Communication (NFC), and so forth, or some combination thereof.

In some embodiments, the presence of the mobile device 34 within the amusement park may be verified using a unique ID or address assigned to the mobile device 34. For example, the server 38 or a node may assign a unique ID or unique address to the mobile device 34. As the mobile device 34 moves about the amusement park 10, the nodes 36 within the amusement park 10 may connect to the mobile device 34, or attempt to connect to the mobile device 34, or otherwise determine that the mobile device 34 is within range via Bluetooth, WiFi, GPS, RFID, NFC, or some other protocol. The nodes 36 may then transmit to the server 38 an indication of whether or not the mobile device 34 is within range of the one or more of the nodes 36. For example, in some embodiments, all of the nodes 36 or a subset of the nodes 36 (e.g., all of the nodes for one or more lands or one or more attractions) may transmit signals to the server 38 indicating whether or not a mobile device 34 with the unique ID or address (e.g., the mobile device 34) is within range. In some embodiments, one or more of the nodes 36 may transmit to the server 38 an indication of what, if any mobile devices are within range. In some embodiments, nodes 36 may push information about mobile devices in range by transmitting data on a schedule, as devices enter the communication range, and so forth. In some embodiments, information may be pulled by the server 38 such that the server requests information about which mobile devices are in range or whether specific mobile devices (e.g., associated with specific unique IDs or addresses) are in range.

The server 38 may then determine that the mobile device 34 is within the amusement park 10 if one of the nodes 36 confirms that the mobile device 34 is within range of the node 36. In some embodiments, the server 38 may be aware of which node 36 or nodes 36 reported that the mobile device 34 was in range. Accordingly, in such embodiments, the server 38 may be able to determine the location of the mobile device 34 within the amusement park 10 based upon which nodes 36 reported that the mobile device 34 was within range. In some embodiments, the nodes 36 may report anonymously whether a mobile device 34 is within range, such that the server 38 may not be able to determine which particular nodes 36 the mobile device 34 is near. In some embodiments, the nodes 36 may be anonymized throughout the park, such that the server 38 only knows whether or not the mobile device 34 is located inside the amusement park 10, whereas in some embodiments, the nodes 36 may be anonymized within a land or an attraction, such that the server 38 knows that the mobile device 34 is in a part or section of the park without knowing the exact location of the mobile device 34 within the amusement park 10.

Verification that a mobile device 34 is located within the amusement park 10 may be facilitated via an application running on the mobile device 34. For example, a guest may install an amusement park application on his or phone to view attraction wait times, join virtual queues, view maps of the amusement park, place orders for food, and so forth. Accordingly, a guest may utilize the application to establish his or her location within the amusement park (e.g., using the guest's mobile device as a proxy for the guest's location). By utilizing the application, the guest may set preferences for how he or she wishes to verify their location in the park. For example, some guests may be willing to share location data, either indefinitely or for a limited period of time. Other guests may wish not the share location data, but may authorize use of Bluetooth, WiFi, GPS, RFID, NFC, or some other protocol to verify his or her location.

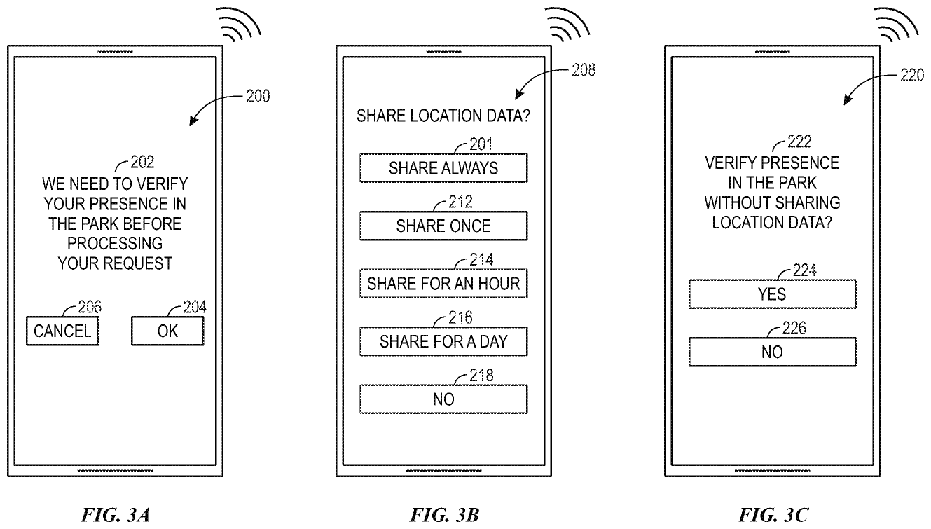

FIGS. 3A-3C illustrate screens of a mobile application, which may run on the mobile device 34 shown in FIGS. 1 and 2, used to verify a guest's presence within an amusement park. FIG. 3A illustrates a screen 200 of an application displaying a notification that a guest's presence in the park must be verified before a request is processed. As previously described, the mobile application running on a mobile device may be used to join a virtual queue to experience an attraction, place an order for food, order or reserve merchandise or souvenirs, participate in promotions (e.g., give-aways, special edition merchandise releases, etc.) within the amusement park, attend, join queue for, or reserve tickets for events within the amusement park, signup to receive messages (e.g., related to weather, safety, attractions being closed, etc.) intended for guests within the amusement park, and so forth. However, before allowing a guest to perform some functions via the application, an operator of the amusement park may wish to verify that the guest is actually located within the park. The operator of the amusement park may limit some functionality of the mobile application to mobile devices that have verified that the mobile device is located within the amusement park. Accordingly, in response to a guest submitting a request to perform some function that requires verification that the guest is in the park, the mobile application may display the notification 202 that presence in the park must be verified before the request is processed. The screen 200 may include an OK button 204 that, when selected, initiates location verification, and a cancel button 206 that, when selected, cancels the request.

FIG. 3B illustrates a screen 208 of the application that appears once the location verification has been initiated. As shown, the screen 208 asks if the guest wishes to share location data of the mobile device and includes a number of options. For example, the screen 208 may include options for always sharing location data (210), sharing location data once (212), sharing location data for an hour (214), sharing location data for the day (216), and declining to share location data (218). If the guest declines to share location data by selecting button 218, the mobile application may display the screen 220 shown in FIG. 3C. As shown, the screen 220 includes a notification 222 asking if the guest wishes to verify their presence in the park without sharing location data. If the user selects button 224, the mobile application will verify the presence of the mobile device within the amusement park using the techniques described herein (e.g., using one or more nodes within the amusement park) instead of using the location data of the mobile device. If the user selects button 226, the mobile application may proceed to cancel the request or return to the screen 200 shown in FIG. 3A.

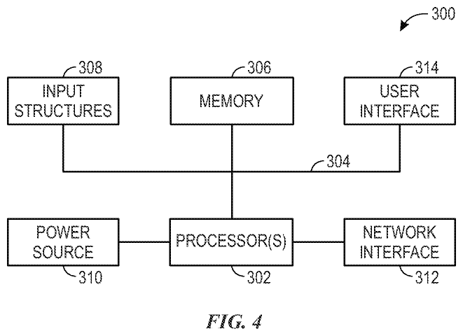

FIG. 4 illustrates a block diagram of example components of a computing device 300 that are configured to be used as the mobile device 34, the nodes 36, and/or the cloud/remote server 38, or some other device within the amusement park 10 shown in FIG. 1. As used herein, a computing device 300 may be implemented as one or more computing systems including laptop, notebook, desktop, tablet, or workstation computers, as well as server type devices, network devices, such as routers, switches, edge devices, etc., or portable, communication type devices, such as cellular telephones and/or other suitable computing devices.

As illustrated, the computing device 300 includes various hardware components, such as one or more processors 302, one or more busses 304, memory 306, input structures 308, a power source 310, a network interface 312, a user interface 314, and/or other computer components useful in performing the functions described herein.

The one or more processors 302 (e.g., processing circuitry) may include, in certain implementations, microprocessors configured to execute instructions stored in the memory 306 or other accessible locations. Alternatively, the one or more processors 302 may be implemented as application-specific integrated circuits (ASICs), field-programmable gate arrays (FPGAs), and/or other devices designed to perform functions discussed herein in a dedicated manner. As will be appreciated, multiple processors 302 or processing components may be used to perform functions discussed herein in a distributed or parallel manner.

The memory 306 may encompass any tangible, non-transitory medium for storing data or executable routines. Although shown for convenience as a single block in FIG. 4, the memory 306 may encompass various discrete media in the same or different physical locations. The one or more processors 302 may access data in the memory 306 via one or more busses 304. In some embodiments, the various components may communicate with one another wirelessly.

The input structures 308 may allow a user to input data and/or commands to the device 300 and may include mice, touchpads, touchscreens, keyboards, controllers, and so forth. The power source 310 can be any suitable source for providing power to the various components of the computing device 300, including line and battery power. In the depicted example, the device 300 includes a network interface 312. Such a network interface 312 may allow communication with other devices on a network using one or more communication protocols. In the depicted example, the device 300 includes a user interface 314, such as a display that may display images or data provided by the one or more processors 302. The user interface 314 may include, for example, a monitor, a display, and so forth. As will be appreciated, in a real-world context a processor-based system, such as the computing device 300 of FIG. 4, may be employed to implement some or all of the present approach, such as performing the functions of the mobile device 34, the nodes 36, and/or the cloud/remote server 38 shown in FIG. 1, as well as other memory-containing devices.

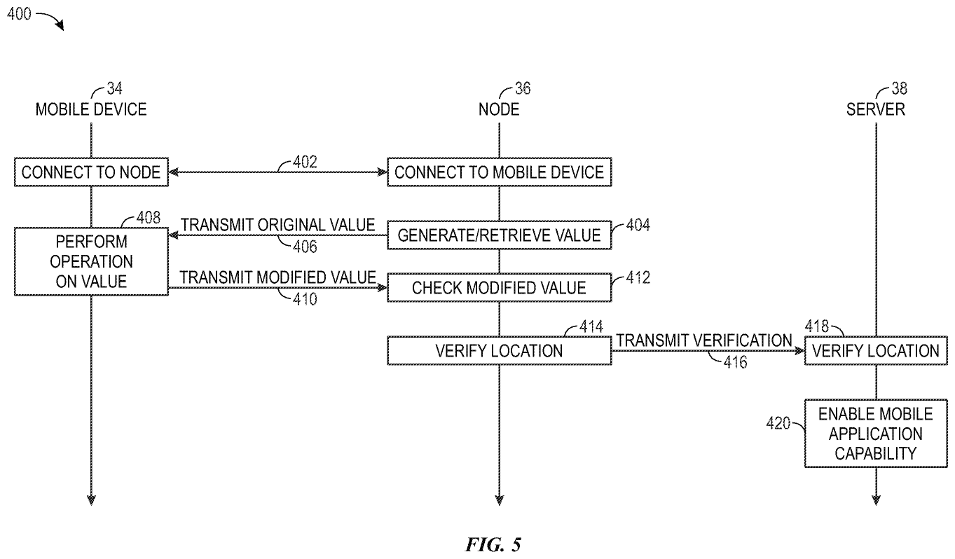

FIG. 5 is a swim lane diagram 400 illustrating an embodiment of a process for verifying a mobile device's presence in an amusement park, or some other area (e.g., a geographical area) with set boundaries. At 402, a connection is established between the mobile device 34 and a node 36 within the amusement park. The connection may be established by either the mobile device 34 or the node 36. At block 404, the node generates or retrieves a value to be used during the verification process. In some embodiments, the value may include or be associated with a key-value pair that includes a public key and/or a private key. For example, in some embodiments, the value may be a value stored in a key-value table with a particular key (e.g., a public key, a private key, etc.). In some embodiments, the value may itself be a key (e.g., a public key, a private key, etc.). In some embodiments, the value may be an alphanumeric character string specifically generated for the verification process.

At 406, the node transmits the original value to the mobile device 34 via the established connection. At 408, the mobile device 34 performs an operation on the received original value. For example, the mobile device 34 may use a locally stored key (e.g., a private key or a public key) to hash the value or perform some other operation on the value that transforms or modifies the value. At 410, the modified value is transmitted back to the node 36. At block 412, the node 36 checks the modified value to confirm that the original value was modified by the mobile device 34 in the way the node 36 expected (e.g., confirming that the mobile device has the correct key and used the correct key to hash the original value). In some embodiments, checking the modified value may include referencing a hash table, a table of key-value pairs, and so forth. At block 414, after the modified value has been checked, the node 36 considers the location of the mobile device 34 to be confirmed within the amusement park. At 416, the node 36 transmits the verification of the location to the server 38. After the verification of the location of the mobile device 34 within the amusement park has been received by the server 38, the server 38 considers the location of the mobile device 34 within the amusement park verified. At block 420, the server 38 enables the mobile application capability for which the location of the mobile device 34 was verified.

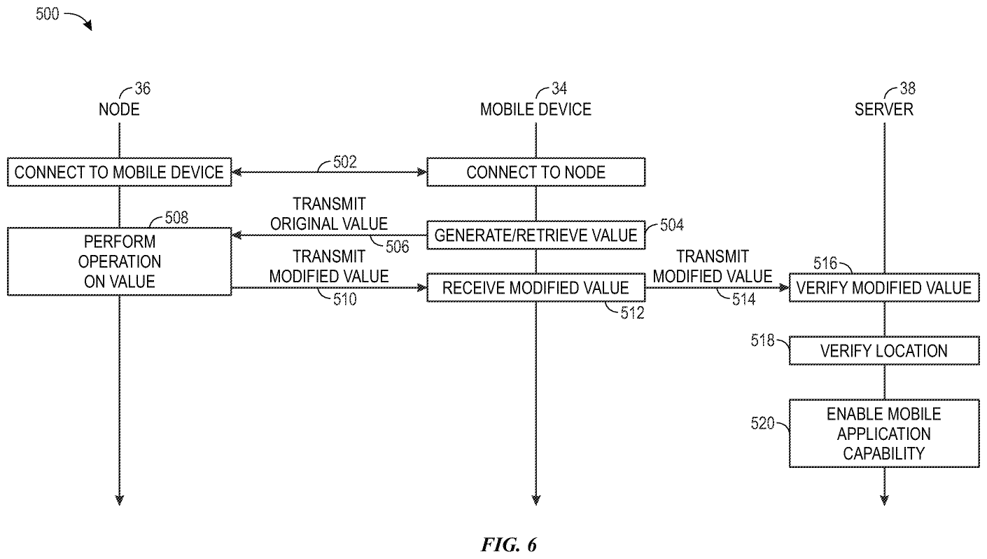

FIG. 6 is a swim lane diagram 500 illustrating an embodiment of a process for verifying a mobile device's presence in an amusement park, or some other area with set boundaries. At 502, a connection is established between the mobile device 34 and a node 36 within the amusement park. The connection may be initiated by either the mobile device 34 or the node 36. At block 504, the mobile device 34 generates a value to be used during the verification process. For example, the value may include or be associated with a key-value pair that includes a public key and/or a private key. In some embodiments, the value may be a value stored in a key-value table with a particular key (e.g., a public key, a private key, etc.). In some embodiments, the value may itself be a key (e.g., a public key, a private key, etc.). In some embodiments, the value may be an alphanumeric character string specifically generated for the verification process. At 506, the mobile device 34 transmits the original value to the node 36 via the connection. At block 508, the node 36 performs an operation on the received original value. For example, the node 36 may use a locally stored key (e.g., a private key or a public key) to hash the value or perform some other operation on the value that modifies the value. At 510, the modified value is transmitted back to the mobile device 34. At block 512, the mobile device 34 receives the modified value and transmits (514) the modified value to the server 38. At block 516, the server 38 checks the modified value to confirm that the original value was modified by the node 36 in the way the server 38 expected (e.g., confirming that the node 36 has the correct key and used the correct key to hash the original value). In some embodiments, checking the modified value may include referencing a hash table, a table of key-value pairs, and so forth. At block 518, after the modified value has been checked, the server 38 considers the location of the mobile device 34 to be confirmed within the amusement park. After the verification of the modified value, the server 38 considers the location of the mobile device 34 within the amusement park verified. At block 520, the server 38 enables the mobile application capability for which the location of the mobile device was verified.

The present disclosure is directed to techniques for verifying the presence of a mobile device within a location defined by a boundary (e.g., an amusement park). Specifically, the amusement park may have a network that communicatively couples multiple network nodes. A zero-knowledge proof (ZKP), and more specifically, a witness indistinguishable proof (WIP), may be performed between the mobile device and one of the network nodes to verify the mobile device's presence within the amusement park. For example, the mobile device establishes a connection with a network node. A value may be transmitted from the mobile device to the network node, or from the network node to the mobile device. The value may be an alphanumeric character string. In some embodiments, the value may be a key (e.g., an encryption key, such as a public key or a private key), a value of a key-value pair associated with a public key or a private key and retrieved from a table, an alphanumeric character string that is not associated with a key, and so forth. Upon receipt of the value, the network node or the mobile device modifies the value by performing some operation. For example, the value may be hashed using a locally stored public or private key, or some other operation may be performed on the value to modify the value in a predictable way. The modified value may then be sent back to the mobile device or the network node. Upon receipt of the modified value, the mobile device or the network node may transmit the modified value to a server for verification, or the mobile device or the network node may verify the modified value locally by comparing the modified value to an expected value for the modified value (e.g., retrieved from a hash table). If the received modified value matches the expected value for the modified value, the location of the mobile device is verified and one or more location-restricted capabilities are enabled for the mobile device. In some embodiments, which of the network nodes was used to verify the presence of the mobile device within the amusement park may be obscured from the server.

By utilizing the disclosed techniques, a mobile device's location within an amusement park can be established without having access to the mobile device's location data. Accordingly, certain features of a mobile application running on the mobile device may be protected from abuse my mobile devices that are not present at the amusement park, thus maintaining a positive experience for guests at the amusement park, while also maintaining the privacy of guests present at the amusement park with regard to specific location within the amusement park.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform) ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A network node for location verification, the network node comprising:
processing circuitry; and
memory, accessible by the processing circuitry and storing instructions that, when executed by the processing circuitry, cause the processing circuitry to perform operations comprising:
establishing a connection with a mobile device;
transmitting, to the mobile device, a value;
receiving, from the mobile device, a modified value generated by the mobile device in response to receiving the value;
comparing the modified value to an expected value of the modified value;
in response to the modified value matching the expected value of the modified value, generating a verification that the mobile device is within range of distance of the network node; and
transmitting the verification to a server.

2. The network node of claim 1, wherein the operations comprise receiving, from the mobile device, prior to transmitting the value, a request to verify presence of the mobile device within an area defined by a boundary.

3. The network node of claim 2, wherein the area defined by the boundary comprises an amusement park, a specific section within the amusement park, or both.

4. The network node of claim 1, wherein the operations comprise retrieving the expected value of the modified value from a hash table.

5. The network node of claim 1, wherein the expected value of the modified value is based on hashing the value with a key.

6. The network node of claim 1, wherein the operations comprise retrieving the value from a key-value table.

7. The network node of claim 1, wherein the operations comprise generating the value in response to establishing the connection with the mobile device.

8. The network node of claim 1, wherein the verification does not identify the network node from a plurality of network nodes.

9. A non-transitory computer readable medium storing instructions that, when executed by processing circuitry, cause the processing circuitry to perform operations comprising:
establishing connection with a network node, wherein the network node is one of a plurality of network nodes communicatively coupled to a network;
transmitting, to the network node, a value;
receiving, from the network node, a modified value generated by the network node in response to receiving the value;
transmitting the modified value to a server; and
receiving, from the server, an indication that one or more location-restricted capabilities of a mobile application are enabled based on the modified value matching an expected value of the modified value.

10. The non-transitory computer readable medium of claim 9, wherein the modified value comprises a hash of the value.

11. The non-transitory computer readable medium of claim 9, wherein the operations comprise transmitting, to the network node, prior to transmitting the value, a request to verify presence of a mobile device comprising the processing circuitry within an area defined by a boundary.

12. The non-transitory computer readable medium of claim 9, wherein the value comprises a key.

13. The non-transitory computer readable medium of claim 9, wherein the value is part of a key-value pair that includes a key.

14. The non-transitory computer readable medium of claim 9, wherein the value comprises an alphanumeric character string.

15. The non-transitory computer readable medium of claim 9, wherein the modified value transmitted to the server does not identify the network node from the plurality of network nodes.

16. A method for location verification, comprising:
receiving, from a mobile device, a modified value generated by a network node in response to receiving an original value from the mobile device, wherein the network node is one of a plurality of network nodes communicatively coupled to a network;
comparing the modified value to an expected value of the modified value;
in response to the modified value matching the expected value of the modified value, determining that the mobile device is located inside of a boundary defining a geographical area; and
in response to the determining that the mobile device is located inside of the boundary defining the geographical area, enabling one or more location-restricted capabilities of a mobile application by the mobile device.

17. The method of claim 16, comprising retrieving the expected value of the modified value from a hash table.

18. The method of claim 16, wherein the expected value of the modified value is based on hashing the value with a key.

19. The method of claim 16, wherein the modified value received from the mobile device does not identify the network node from the plurality of network nodes.

20. The method of claim 16, wherein the one or more location-restricted capabilities of the mobile application by the mobile device comprise entering a queue for an attraction, ordering food, ordering merchandise, reserving tickets for an event, or any combination thereof.
